(19) United States
(12) Patent Application Publication
(10) Pub. No.: US 2018/0250627 A1
(43) Pub. Date: Sep. 6, 2018

(54) PLANT AND METHOD FOR THE MEMBRANE PERMEATION TREATMENT OF A GASEOUS FEEDSTREAM COMPRISING METHANE AND CARBON DIOXIDE

(71) Applicant: L'Air Liquide, Societe Anonyme pour l'Etude et l'Exploitation des Procedes Georges Claude, Paris (FR)

(72) Inventors: Golo ZICK, Fontaine (FR); Guenael PRINCE, Saint Egreve (FR); Nicolas PAGET, Saint Martin d'Heres (FR)

(73) Assignee: L'Air Liquide, Societe Anonyme pour l'Etude et l'Exploitation des Procedes Georges Claude, Paris (FR)

(21) Appl. No.: 15/910,241

(22) Filed: Mar. 2, 2018

(30) Foreign Application Priority Data
Mar. 2, 2017 (FR) FR 1751688

(51) Int. Cl. B01D 53/22; C10L 3/10

(52) U.S. Cl. CPC B01D 53/226; C10L 2290/46; C10L 2290/548; C10L 3/104

(57) ABSTRACT

A plant for the membrane permeation treatment of a gaseous feedstream comprised of at least methane and carbon dioxide for producing a methane-enriched gaseous stream, comprises: a first membrane separation unit able to receive the gaseous feedstream and to produce a first carbon dioxide-enriched permeate and a first methane-enriched retentate, a second membrane separation unit able to receive the first retentate and to produce a second carbon dioxide-enriched permeate and a second methane-enriched retentate, a gas-gas ejector able to increase the pressure of the first permeate to a pressure of between 2 and 6 bar, more preferably between 3 and 4 bar, and a third membrane separation unit able to receive the first permeate compressed in the ejector and to produce a third methane-enriched retentate and a third CO2-enriched permeate.

### CROSS-REFERENCE TO RELATED APPLICATIONS

This application claims the benefit of priority under 35 U.S.C. § 119 (a) and (b) to French patent application No. FR1751688, filed Mar. 2, 2017, the entire contents of which are incorporated herein by reference.

### BACKGROUND

### Field of the Invention

The present invention relates to a plant and to a method for membrane permeation treatment of a gaseous stream containing at least methane and carbon dioxide for producing a methane-rich gaseous stream.

It pertains more particularly to the purification of biogas, with the aim of producing biomethane that meets the specifications for injection into a natural gas network.

### Related Art

Biogas is the gas produced during the breakdown of organic matter in the absence of oxygen (anaerobic fermentation), also referred to as methanization. This may be a natural breakdown—it is observed thus in marshes or municipal landfill sites—but the production of biogas may also result from the methanization of waste in a dedicated reactor, referred to as a methanizer or digester.

Owing to its main constituents—methane and carbon dioxide—biogas is a potent greenhouse gas; at the same time, it is also a significant source of renewable energy against the background of the increasing scarcity of fossil energies.

Biogas predominantly contains methane (CH4) and carbon dioxide (CO2) in proportions that vary depending on the way it is obtained, but also, in smaller proportions, contains water, nitrogen, hydrogen sulfide, oxygen, and also other organic compounds, in trace amounts.

Depending on the organic matter broken down and the techniques employed, the proportions of the components differ; on average, however, the biogas, on a dry gas basis, comprises from 30% to 75% of methane, from 15% to 60% of CO2, from 0% to 15% of nitrogen, from 0% to 5% of oxygen, and trace compounds.

Value is derived from the biogas in a variety of ways. It may, after slight treatment, be processed in the vicinity of the production site to provide heat, electricity or a mixture of the two (cogeneration); the high carbon dioxide content reduces its calorific value, increases the costs of compression and transport, and limits the economic advantage of processing it for this nearby use.

A more thorough purification of the biogas allows it to be used more broadly; more particularly, a thorough purification of the biogas produces a biogas that is purified to the specifications of natural gas and which could be used as a substitute for such gas; the biogas thus purified is “biomethane”. Biomethane therefore supplements natural gas resources with a renewable portion produced within the regions; it can be used for exactly the same uses as the natural gas of fossil origin. It may supply a natural gas network, a vehicle filling station, and it may also be liquefied for storage in the form of liquefied natural gas (LNG), etc.

The ways in which value is derived from the biomethane are determined in dependence on the local contexts: local energy requirements, options for processing as biomethane fuel, presence nearby of networks for distribution or transport of natural gas in particular. Creating synergies between the various operators working in a region (farmers, manufacturers, public bodies), the production of biomethane helps regions to acquire a greater self-sufficiency in terms of energy.

A number of steps must be accomplished between the collection of the biogas and the production of biomethane, the end product which can be compressed or liquefied.

More particularly, a number of steps are necessary before the treatment whose aim is to separate the carbon dioxide to produce a purified methane stream. A first step is that of compressing the biogas which has been produced and transported at atmospheric pressure; this compression may be obtained—conventionally—via a lubricated screw compressor. The subsequent steps are aimed at stripping the biogas of the corrosive components, these being the hydrogen sulfide and the volatile organic compounds (VOCs); the technologies used are, conventionally, pressure swing adsorption (PSA) and capture on activated carbon. The next step is that of separating the carbon dioxide in order, finally, to provide methane at the purity required for its subsequent use.

Carbon dioxide is a contaminant which is typically present in natural gas, from which it must usually be stripped. Various technologies are employed for this purpose, depending on the situation: among these technologies, membrane technology is particularly effective when the CO2 content is high; it is therefore particularly effective for separating the CO2 present in biogas, and more particularly in landfill gas.

The membrane processes of gas separation that are used for the purification of a gas, whether using one or more membrane stages, must enable the production of a gas having the requisite quality, at low cost, while minimizing the losses of the gas whose value is to be enhanced. Accordingly, in the case of biogas purification, the separation performed is primarily a CH4/CO2 separation, which must enable the production of a gas containing—depending on its use—more than 85% of CH4, preferably more than 95% of CH4, more preferably more than 97.5% of CH4, while minimizing the losses of CH4 in the residual gas and the purification cost, the latter being in substantial part linked to the electricity consumption of the device for compressing the gas upstream of the membranes.

One known solution involves using a three-stage membrane system (FIG. 1) in which the permeate 4 of the 1^{st} stage undergoes a second separation in the third membrane stage, before being mixed into the permeate 5 of the 2^{nd} stage, to be recycled. This three-stage system is used without recompression of the permeate of the 1^{st} stage, and the permeate of the 2^{nd} stage and the residual product of the 3^{rd} stage are recycled to the inlet of the membrane system. This three-stage membrane system improves the methane yield relative to a two-stage membrane system.

A key parameter of the 3-stage configuration is the pressure of the permeate of the first stage, which is the admission pressure of the third stage. Consequently, two contradictory objectives are in opposition to one another:

1. The pressure must be minimized in order to enhance the effectiveness of the first stage;

2. The pressure must be maximized in order to enhance the effectiveness of the third stage or to reduce the number of membrane modules requiring installation.

To demonstrate the effect of the pressure of the permeate of the first stage, FIG. 2 shows the change in the CH4 yield and in the standardized specific cost as a function of the pressure of the permeate of the first stage. FIG. 2 shows that the minimization of the pressure is greater if all of the other parameters are retained. In order to benefit from maximum effectiveness of the third stage, it would be desirable nevertheless to increase the admission pressure of that stage, as may be done by means of a mechanical compressor.

### SUMMARY OF THE INVENTION

One solution according to the invention is a plant for the membrane permeation treatment of a gaseous feedstream comprising at least methane and carbon dioxide for producing a methane-enriched gaseous stream, comprising:

a first membrane separation unit able to receive the gaseous feedstream and to produce a first carbon dioxide-enriched permeate and a first methane-enriched retentate,

a second membrane separation unit able to receive the first retentate and to produce a second carbon dioxide-enriched permeate and a second methane-enriched retentate,

a gas-gas ejector able to increase the pressure of the first permeate to a pressure of between 2 and 6 bar, more preferably between 3 and 4 bar, and

a third membrane separation unit able to receive the first permeate compressed in the ejector and to produce a third methane-enriched retentate and a third CO2-enriched permeate.

### BRIEF DESCRIPTION OF THE FIGURES

FIG. 1 is a schematic of a prior art three-stage membrane-based separation process in which the permeate from the first stage is separated in a third stage without recompression.

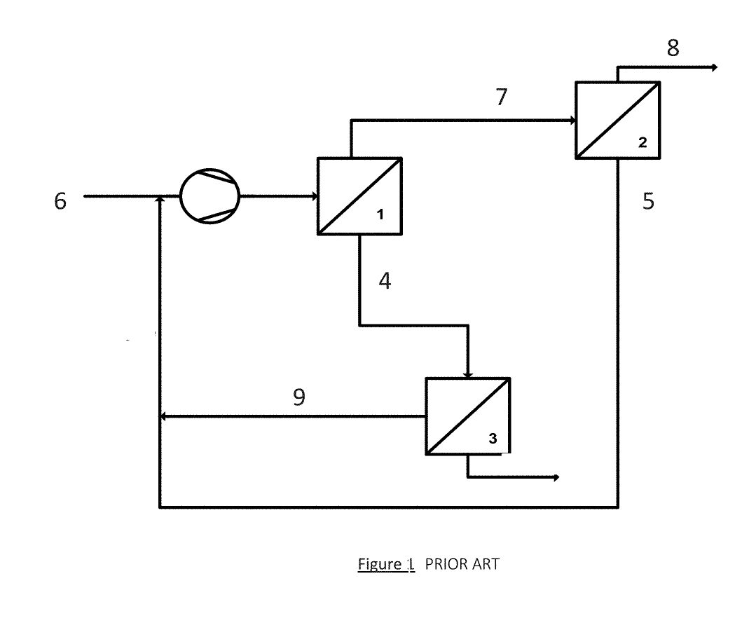

FIG. 2 is a graph of the change in the CH₄ yield and in the standardized specific cost as a function of the pressure of the permeate of the first stage for the three-stage membrane-based separation process.

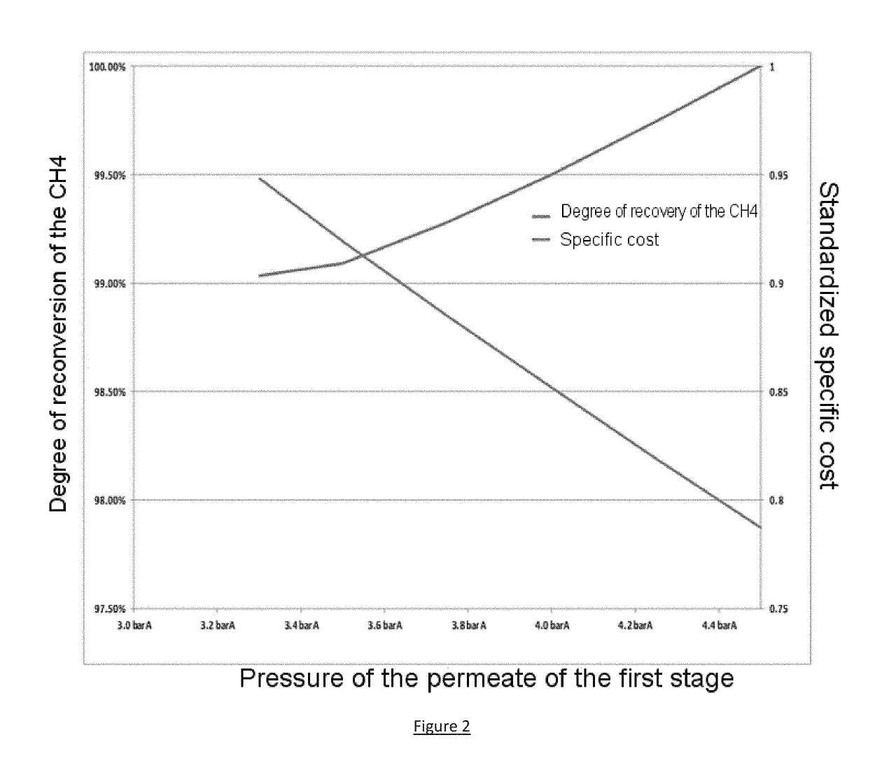

FIG. 3 is a schematic of the method and system of the invention.

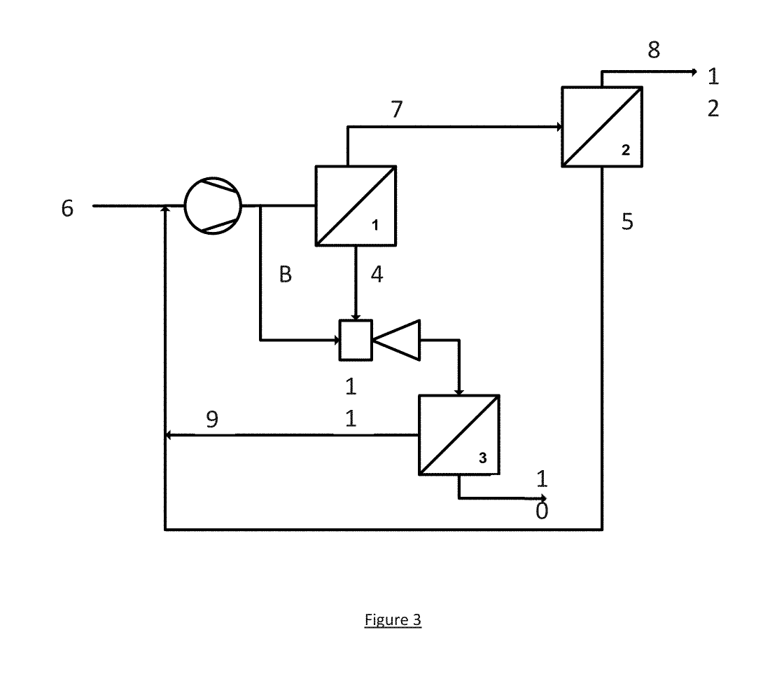

### DETAILED DESCRIPTION OF THE INVENTION

One solution according to the invention is a plant for the membrane permeation treatment of a gaseous feedstream 6 comprising at least methane and carbon dioxide for producing a methane-enriched gaseous stream 12, comprising:

a first membrane separation unit 1 able to receive the gaseous feedstream and to produce a first carbon dioxide-enriched permeate 4 and a first methane-enriched retentate 7,

a second membrane separation unit 2 able to receive the first retentate 7 and to produce a second carbon dioxide-enriched permeate 5 and a second methane-enriched retentate 8,

a gas-gas ejector 11 able to increase the pressure of the first permeate 4 to a pressure of between 2 and 6 bar, more preferably between 3 and 4 bar, and

a third membrane separation unit 3 able to receive the first permeate 4 compressed in the ejector and to produce a third methane-enriched retentate 9 and a third CO2-enriched permeate 10.

Where appropriate, the plant according to the invention may have one or more of the following characteristics:

the said plant comprises a means for conveying a portion B of the gaseous feedstream to the gas-gas ejector, and the gas-gas ejector is a gas-gas ejector employing the portion B of the gaseous feedstream as motive gas,

the said plant comprises a compressor able to increase the pressure of the gaseous feedstream to a pressure of greater than 8 bar, more preferably greater than 13 bar, upstream of the first membrane separation unit,

the said plant comprises a fourth membrane separation unit able to receive the third permeate and to produce a fourth methane-enriched retentate and a fourth CO2-enriched permeate,

the said plant comprises means for joint recycling of the third retentate and of the second permeate upstream of the compressor,

the said plant comprises means for joint recycling of the fourth retentate and of the second permeate upstream of the compressor,

the said plant comprises means for evacuating the third permeate outside the plant,

the said plant comprises means for evacuating the fourth retentate outside the plant,

the membranes of the three membrane separation units have the same selectivity or different selectivities.

Another subject of the present invention is a method for membrane permeation treatment of a gaseous feedstream 6 comprising at least methane and carbon dioxide for producing a methane-enriched gaseous stream 12, employing a plant as defined in the invention and comprising:

a) a first step of membrane separation of the gaseous feedstream in the first membrane separation unit 1, producing a first carbon dioxide-enriched permeate 4 and a first methane-enriched retentate 7,

b) a second step of membrane separation of the first retentate 7 in the second membrane separation unit 2, producing a second carbon dioxide-enriched permeate 5 and a second methane-enriched retentate 8,

c) a step of compression of the first permeate 4 to a pressure of between 2 and 6 bar by means of the gas-gas ejector 11,

d) a third step of membrane separation of the first permeate 4 compressed in the ejector 11 in the third membrane separation unit 3, producing a third methane-enriched retentate 9 and a third CO2-enriched permeate 10.

Where appropriate, the method according to the invention may have one or more of the features below:

the gas-gas ejector 11 employs a portion B of the gaseous feedstream as motive gas.

upstream of the first membrane separation unit 1, the gaseous feedstream 6 is compressed to a pressure of greater than 8 bar, more preferably greater than 13 bar.

the said method comprises a fourth step of membrane separation of the third permeate, producing a fourth methane-enriched retentate and a fourth CO2-enriched permeate.

the third retentate 9 and the second permeate 5 are recycled jointly upstream of the compressor.

the fourth retentate and the second permeate are recycled jointly upstream of the compressor.

In the context of the invention, the gaseous feedstream is preferably biogas originating, for example, from a digester, a fermenter, a waste disposal facility or a WTP (WTP=wastewater treatment plant).

The plant and the method according to the invention, by increasing the pressure of the first permeate to a pressure of between 2 and 6 bar, in other words by bringing about a “gentle” increase in the pressure, enable either a reduction in the membrane surface area for installation at the third stage, and therefore a reduction in the capital costs while retaining a constant yield, or an increase in the effectiveness of the plant/the method according to the invention.

Since the motive gas employed by the gas-gas ejector is the gaseous feed stream from the first stage, there is no risk of pollution. The ejector, moreover, has the advantage of containing no moving parts.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

What is claimed is:

1. Plant for the membrane permeation treatment of a gaseous feedstream comprising at least methane and carbon dioxide for producing a methane-enriched gaseous stream, comprising:
a first membrane separation unit adapted and configured to receive the gaseous feedstream and to produce a first carbon dioxide-enriched permeate and a first methane-enriched retentate;
a second membrane separation unit adapted and configured to receive the first retentate and to produce a second carbon dioxide-enriched permeate and a second methane-enriched retentate;
a gas-gas ejector adapted and configured to increase the pressure of the first permeate to a pressure of between 2 and 6 bar and yield a compressed first permeate; and
a third membrane separation unit able to receive the compressed first permeate in the ejector and to produce a third methane-enriched retentate and a third CO2-enriched permeate.

2. The plant of claim 1, wherein a portion B of the gaseous feedstream is conveyed from the first membrane separation unit to the gas-gas ejector where it is used as motive gas in the gas-gas ejector.

3. The plant of claim 1, further comprising a compressor adapted and configured to increase the pressure of the gaseous feedstream to a pressure of greater than 8 barupstream of the first membrane separation unit.

4. The plant of claim 3, further comprising a fourth membrane separation unit adapted and configured to receive the third permeate and to produce a fourth methane-enriched retentate and a fourth CO2-enriched permeate.

5. The plant of claim 3, wherein the third retentate and the second permeate are recycled upstream of the compressor.

6. The plant of claim 4, wherein the fourth retentate and the second permeate are recycled upstream of the compressor.

7. The plant of claim 3, wherein the third permeate is evacuated outside of the plant.

8. The plant of claim 4, wherein the fourth retentate is evacuated outside the plant.

9. The plant of claim 1, wherein the membranes of the three membrane separation units have a same selectivity.

10. The plant of claim 1, wherein the membranes of the three membrane separation units have different selectivities.

11. Method for membrane permeation treatment of a gaseous feedstream comprising at least methane and carbon dioxide for producing a methane-enriched gaseous stream, comprising the steps of:
a) separating the gaseous feedstream with the first membrane separation unit into a first carbon dioxide-enriched permeate and a first methane-enriched retentate;
b) separating the first retentate with the second membrane separation unit into a second carbon dioxide-enriched permeate and a second methane-enriched retentate;
c) compressing the first permeate to a pressure of between 2 and 6 bar using the gas-gas ejector to produce a compressed first permeate; and
d) separating the compressed first permeate with a third membrane separation unit into a third methane-enriched retentate and a third CO2-enriched permeate.

12. The method of claim 11, wherein the gas-gas ejector uses a portion B of the gaseous feedstream as motive gas.

13. The method of claim 12, wherein upstream of the first membrane separation unit, the gaseous feedstream is compressed to a pressure of greater than 8 bar.

14. The method of claim 13, further comprising a step of separating the third permeate with a fourth membrane separation unit into a fourth methane-enriched retentate and a fourth CO2-enriched permeate.

15. The method of claim 13, wherein the third retentate and the second permeate are recycled jointly upstream of the compressor.

16. The method of claim 14, wherein the fourth retentate and the second permeate are recycled jointly upstream of the compressor.
